(19) United States
(12) Patent Application Publication
(10) Pub. No.: US 2019/0239030 A1
(43) Pub. Date: Aug. 1, 2019

(54) NETWORKING AND SPEECH MONITORING SYSTEM AND METHOD OF USE

(71) Applicant: Rogelio Pasetes, McKinney, TX (US)

(72) Inventor: Rogelio Pasetes, McKinney, TX (US)

(21) Appl. No.: 16/265,146

(22) Filed: Feb. 1, 2019

Related U.S. Application Data
(60) Provisional application No. 62/625,224, filed on Feb. 1, 2018.

(51) Int. Cl. H04W 4/029; G10L 15/22; G10L 15/30

(52) U.S. Cl. CPC H04W 4/029; G10L 2015/225; G10L 15/30; G10L 15/22

(57) ABSTRACT

A networking system includes a server to receive and process data; a computing device having a location tracking device and to communicate wirelessly with the server and a second computing device; a networking platform to be implemented through the computing device, the networking platform to perform the steps of: determining a location of the computing device; receiving a signal from a server related to a second location of the second computing device; determining that the second computing device is within a predetermined range of the first computing device; and receiving contextual information from the second computing device; the contextual information provides information about a second person associated with the second device to a first person associated with the first device.

### BACKGROUND

### 1. Field of the Invention

The present invention relates generally to networking methods and systems, and more specifically, to a networking system for providing information about users to one another as well as providing a means to receive feedback regarding a speech, the feedback being overlaid onto any media playback system track for review and analysis.

### 2. Description of Related Art

Networking methods and systems are well known in the art and are effective means to meet professional acquaintances. Conventionally, large networking events are held, wherein persons interact and meet one another, exchanging contact information. In addition, online networking systems, such as social networking exists for researching and meeting professional contacts remotely.

One of the problems commonly associated with conventional networking is the difficulty remembering persons after the event. For example, it is common for a person to collect a plurality of business cards based on conversation, however, after the fact, the person may have trouble recalling which business card corresponds to which person/conversation. In addition, it would be desirable to receive information about a person before meeting them at the networking event, thereby giving a basis for a conversation and allowing a person to determine which other attendees of the event would be beneficial to meet.

Accordingly, although great strides have been made in the area of networking systems and methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a networking and speech monitoring system in accordance with a preferred embodiment of the present application;

FIG. 2 is a simplified schematic of the platform of the system of FIG. 1;

FIG. 3 is a flowchart of a first functionality of the platform of FIG. 1;

FIG. 4 is a flowchart of a second functionality of the platform of FIG. 1; and

FIG. 5 is a flowchart of a third functionality of the platform of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional networking systems and methods. Specifically, the present invention provides a means to receive information about a person before and during a networking event to aid in in person interactions. In addition, the present invention provides a means to receive feedback from persons regarding a speech presented. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

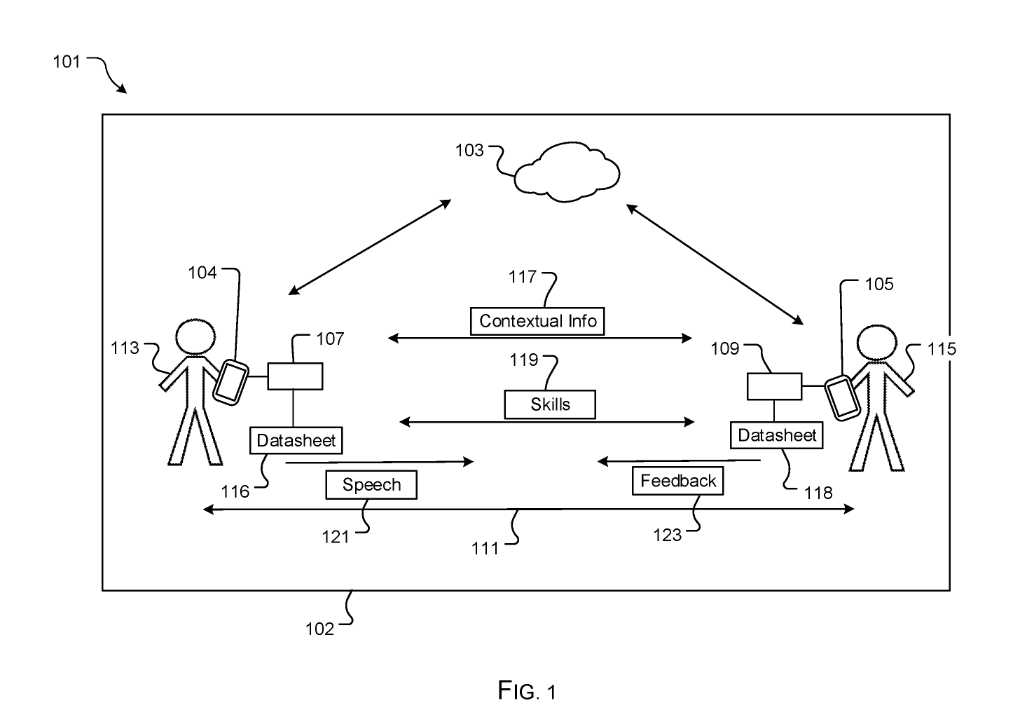

Referring now to the drawings wherein like reference characters identify corresponding or similar elements throughout the several views, FIG. 1 depicts a simplified schematic of a networking system 101 in accordance with a preferred embodiment of the present application. It will be appreciated that system 101 overcomes one or more of the above-listed problems commonly associated with conventional networking systems and methods.

In the contemplated embodiment, system 101 includes a server 103 configured to receive and process data from a plurality of computing devices 104, 105, the plurality of computing devices 104, 105 having location tracking technology incorporated therein. System 101 further includes a networking platform 107, 109 installed on the computing devices and configured to send and receive information from the server.

System 101 includes a predefined and bordered location 102, such as a building, event center, or the like, wherein a networking event is taking place. As shown, platform 107, 109 first determine a distance 111 between a first user 113 and a second user 115. The distance 111 provides a proximity for activation of information sharing between the computing devices. When the first and second users reach a predetermined distance from one another, thereby indicating that they are at the same networking event, the server signals for contextual information 117 to be shared between the users. The contextual information 117 is provided via a contextual data sheet 116, 118 by the users and can include information such as employment, profile pictures, contact information, skills, and the like, thereby providing the users with a basis for a conversation upon their in person meeting. It should be understood that this form of sharing information can eliminate the need to share business cards. In some embodiments, the information is presented to the user for a predetermined time.

Platform 107, 109 further provides a means to correlate skills 119 of the first person and the second person. For example, the first person may input a skill, such as the ability to play soccer, from there the server 103 cross references the first person's skill with skills inputted by the second user. Based on the correlation, a notification can be transmitted to the first person to alert them that the second person shares a skill with them.

Platform 107, 109 further provides a speech presenting function, wherein the first user 113 designates for a recording of a speech 121 that they are presenting. Speech 121 is then presented to an audience, wherein second user 115 (as well as additional users) can provide feedback 123 throughout the speech, the platform then overlaying the feedback with the speech track to provide the first user with tools to review. It should be appreciated that platform 109, provides for anonymous feedback and/or feedback from specifically identified persons.

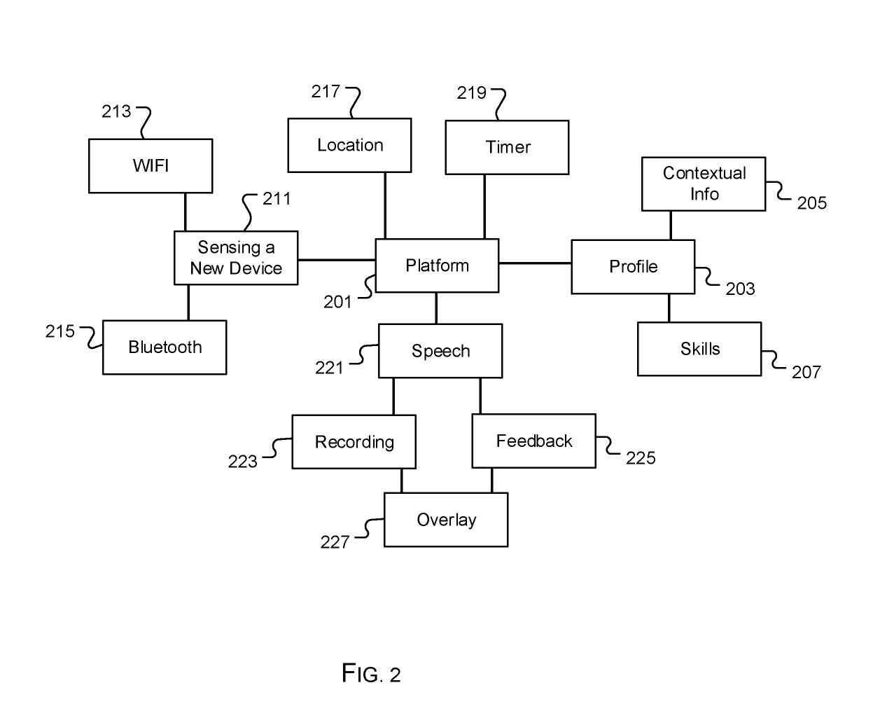

In FIG. 2, a simplified schematic further demonstrates the various features of a platform 201 for use with system 101. Platform 201 includes a profile development portal 203, wherein each user can input contextual information 205 and skills 207. This information can include job skills, employment information, pictures, videos, interests, connections, and the like. Platform 201 further incorporates location tracking technology 209 and technology 211 to detect additional devices having the platform installed therein. IT should be appreciated that technology 211 can include wifi technology 213 and/or Bluetooth technology 215 to allow the computing device to communicate with the server and thereby receive information. Further, platform 201 can including a timing function 217, wherein information is presented for a designated time through the platform to the user.

In some embodiments, platform 201 further includes a speech portal 221 configured to allow a first user to record a speech 223, wherein other users, located within the proximity of the speaker can provide feedback 225, the feedback being either positive or negative, and the platform 201 being configured to overlay 227 the feedback with the recording 223 to provide the speaker with materials to review.

It should be appreciated that one of the unique features believed characteristic of the present application is the providing of contextual data to a first user based on information regarding a second user, when the two users enter a pre-determined proximity.

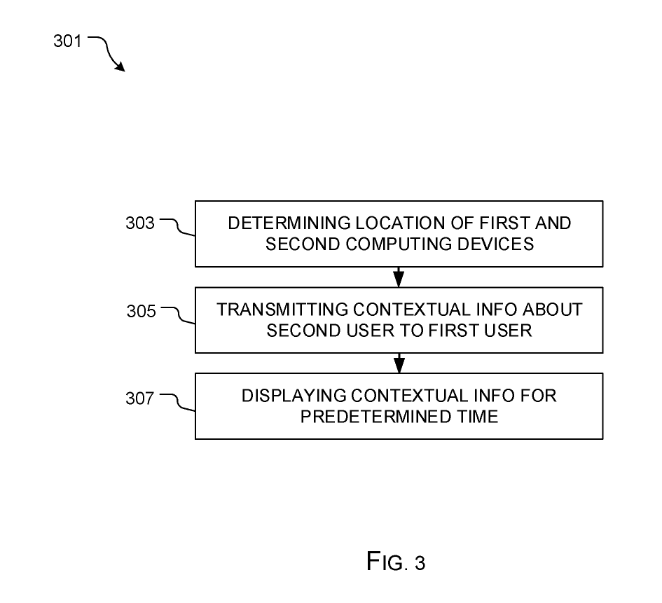

In FIG. 3, a flowchart 301 depicts the first functionality of system 101. During use, the locations of one or more computing devices are determined, thereby determining if two users are in a similar proximity and therefore at the same networking event, as shown with box 303. Based on the two computing devices entering the same location, contextual info is transmitted between the two computing devices, wherein the contextual information is presented to the users for predetermined times, as shown with boxes 305, 307.

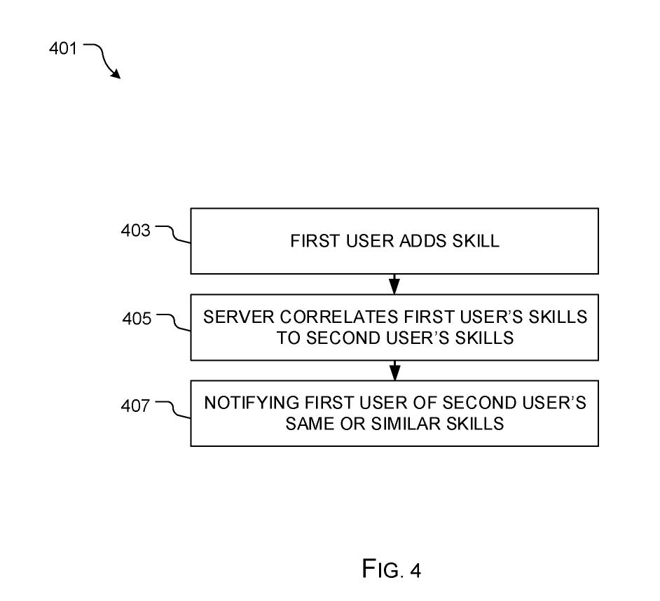

In FIG. 4, a flowchart 401 depicts a second functionality of system 101. During use, the first user adds a skill to their profile within the platform, as shown with box 403. The server receives information regarding the skill and correlates the first user's skill to skills input by a second user, as shown with box 405. If the two skills are the same or similar, the first user receives a notice regarding the similarity, as shown with box 407.

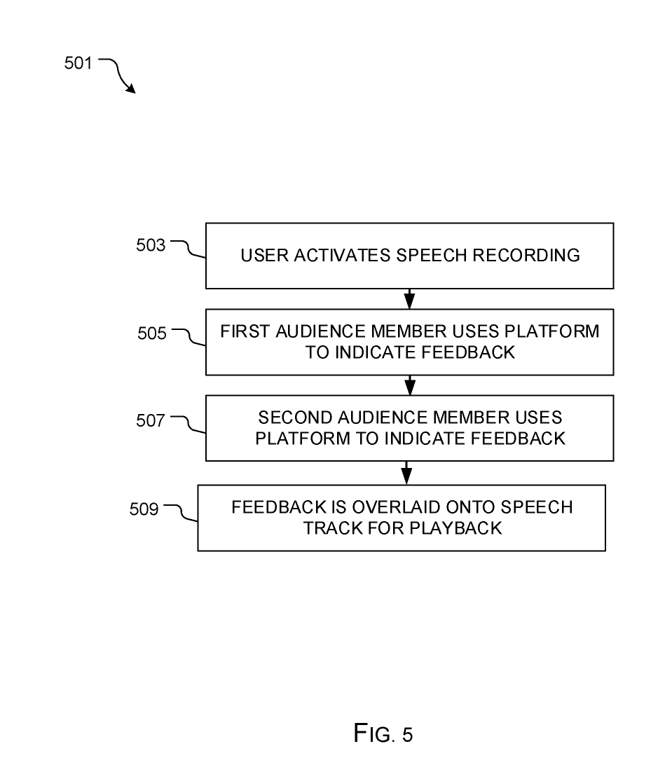

In FIG. 5, a flowchart 501 depicts a third functionality of system 101 regarding the recording and playback of a speech. The first user indicates that they are beginning a speech, wherein the platform, through the computing device begins recording the speech, as shown with box 503. Audience members, who are determined to be within the same proximity, and also have the platform installed, can then indicate positive and/or negative feedback at various times during the speech, wherein this feedback is transmitted to the speaker's platform and overlaid onto the speech recording, as shown with boxes 505, 507, 509. The speaker can then playback the speech and have information regarding when audience members indicated positive and negative feedback. It should be appreciated that many specific forms of feedback are contemplated, such as the providing of a numerical value, wherein the numerical value represents the audience member's satisfaction/dissatisfaction with the speech.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A networking system, comprising:
a server configured to receive and process data;
a computing device having a location tracking device and configured to communicate wirelessly with the server and a second computing device;
a networking platform configured to be implemented through the computing device, the networking platform configured to perform the steps of:
determining a location of the computing device;
receiving a signal from a server related to a second location of the second computing device;
determining that the second computing device is within a predetermined range of the first computing device; and
receiving contextual information from the second computing device;
wherein the contextual information provides information about a second person associated with the second device to a first person associated with the first device.

2. The system of claim 1, wherein the networking platform is configured to further perform the steps of:
receiving a designated skill form the first user;
connecting with the server to determine if the contextual information about the second user includes the designated skill; and
notifying the first user about the contextual information including the designated skill.

3. The system of claim 1, wherein the networking platform is configured to further perform the steps of:
receiving a notification of a beginning of a speech from the first user;
recording the speech;
receiving positive feedback via the server, the positive feedback being inputted from the second user;
receiving negative feedback via the server, the negative feedback being inputted form a third user on a third computing device; and
overlaying the positive feedback and the negative feedback with a recording of the speech.

4. A method of connecting persons at network events, the method comprising:
providing a first computing device associated with a first user and a second computing device associated with a second user, the first computing device and second computing device having location tracking technology incorporated therein;
determining a proximity associated with the first computing device and the second computing device;
determining that the proximity places the first computing device and the second computing device within a predetermined range; and
transmitting contextual information about the second user to the first computing device;
wherein the contextual information includes professional information about the second user.

5. The method of claim 4, further comprising:
activating a timer for an availability of contextual information based on the proximity.

6. The method of claim 4, further comprising:
receiving a first skill designation from the first user;
receiving a second skill designation from the second user; and
correlating the first skill and the second skill to determine if the first and second skills relate.

7. The method of claim 6, further comprising:
providing the first user with an alert that the first skill designation and the second skill designation are related.

8. A method of improving speaking skills, comprising:
providing a first computing device with a platform configured to receive data from a server, the first computing device associated with a speaker;
receiving notice of starting a speech through the platform;
initiating recording of the speech with the platform;
receiving a first feedback from a second user via a second computing device; and
overlaying the first feedback ono the speech;
wherein the first feedback relates to positive or negative resonance.

9. The method of claim 8, further comprising:
receiving a second feedback from a third user via a third computing device; and
overlaying the second feedback on to the speech.
